(19) United States
(12) Patent Application Publication
(10) Pub. No.: US 2025/0004833 A1
(43) Pub. Date: Jan. 2, 2025

(54) EFFICIENT RESOURCE USAGE BY A COURSE

(71) Applicant: INTERNATIONAL BUSINESS MACHINES CORPORATION, ARMONK, NY (US)

(72) Inventors: Philip Siconolfi, Croton on Hudson, NY (US); Jeffrey Bisti, New Paltz, NY (US); Robert Paquin, Poughkeepsie, NY (US)

(21) Appl. No.: 18/343,802

(22) Filed: Jun. 29, 2023

(51) Int. Cl. G06F 9/50

(52) U.S. Cl. CPC G06F 9/5005; G06F 2209/5019

(57) ABSTRACT

A method, computer program product, and computer system for allocating resources to sections of a course. A trained machine learning model (MLM) is executed to initially allocate resources for each section of the course. The trained MLM was previously trained from data of multiple sections of respective historical courses using current instances of a feature vector respectively corresponding to each of the multiple sections. Executing the trained MLM includes using a first instance of a feature vector characterizing the current section as input to the trained MLM. The trained MLM includes a K nearest neighbors (KNN) algorithm and a trained artificial intelligence (AI) model. The resource allocation among the sections is adjusted as deviations from the initially allocated resources to each section. The deviations are based on resource limitations that are specific to each section individually and are not generally encompassed by the sections of the historical courses.

### BACKGROUND

The present invention relates to constructing and implementing a course, and more specifically, to constructing and implementing a course in a manner that makes efficient use of resources used by the course.

### SUMMARY

Embodiments of the present invention provide a method, a computer program product, and a computer system, for allocating resources to sections of a course. The course comprises a plurality of sections that includes a first section and a last section. The method comprises the following steps starting with a current section of the course being the first section of the course.
(a) One or more processors of a computer system execute a trained machine learning model (MLM) to initially allocate resources for the current section of the course. The trained MLM was previously trained from data of multiple sections of respective historical courses using current instances of a feature vector respectively corresponding to each of the multiple sections. Each of the multiple sections is essentially a same section as the current section. Executing the trained MLM comprises using a first instance of a feature vector characterizing the current section as input to the trained MLM. The trained MLM comprises a K nearest neighbors (KNN) algorithm and a trained artificial intelligence (AI) model.
(b) The one or more processors determine whether the current section is the last section and if so then next performing step (c), and if not then re-performing step (a) with the current section being a next section of the course.
(c) The one or more processors adjust resource allocation among the sections as deviations from the initially allocated resources to each section. The deviations are based on resource limitations that are specific to each section individually and are not generally encompassed by the sections of the historical courses. The software resources configured for use by the plurality of sections of the course and for use by sections of other courses are included in a resource registry stored on one or more storage devices of the computer system.

### BRIEF DESCRIPTION OF THE DRAWINGS

FIG. 1 is a flow chart describing an embodiment of a method for allocating resources to sections of a course, in accordance with embodiments of the present invention.

FIG. 2 is a flow chart describing an embodiment of a process of building a resource registry of resources used by the sections of the course and by sections of other courses, in accordance with embodiments of the present invention.

FIG. 3 is a flow chart describing an embodiment of a process of executing a trained machine learning model (MLM) for a current section of the course, in accordance with embodiments of the present invention.

FIG. 4 is a flow chart describing an embodiment of a process of training the MLM, in accordance with embodiments of the present invention.

FIG. 5 is a flow chart describing an embodiment of a process of training an artificial intelligence (AI) model of the MLM, in accordance with embodiments of the present invention.

FIG. 6 is a flow chart describing an embodiment of a process of tracking current section resources, in accordance with embodiments of the present invention.

FIG. 7 is a flow chart describing an embodiment of a process of adjusting resource allocation among the sections of the course, in accordance with embodiments of the present invention.

FIG. 8 depicts a timeline of the course, in accordance with embodiments of the present invention.

FIG. 9 is a process of examining the timeline of FIG. 8, in accordance with embodiments of the present invention.

FIG. 10 is a flow chart of a live implementation of the course in accordance with the resources allocated to the sections of the course, in accordance with embodiments of the present invention.

FIG. 11 illustrates a computer system, in accordance with embodiments of the present invention.

FIG. 12 depicts a computing environment which contains an example of an environment for the execution of at least some of the computer code involved in performing the inventive methods, in accordance with embodiments of the present invention.

### DETAILED DESCRIPTION

Assessment of skills and of skill expertise of employees in an organization is a strategic and business objective.

When designing a course or hackathon with a hands-on element or partitioning system resources for a collaborative sandbox environment, it is easy to exhaust available system resources to the point where availability to the entire course suffers; e.g., where overall capacity is set by restrictions and scaling is unavailable. Preplanning of specific resource capacity for specifics parts of a course can lead to a suboptimal experience if there are more users than are planned for. Existing workarounds are fragile in nature, are not integrated into the courseware, and require deep knowledge of both the system administration and course management side to be fully established. In embodiments of the present invention, the course may be, inter alia, a learning course, an educational course, or a software-based course.

Embodiments of the present invention make it possible for course developers and system administrators to use an artificial intelligence (AI) based resource sharing system to build plans and policies for system access, based on a continuous collection of data points, assuming a linear progression through sections, which allows for a greater number of asynchronous learners on a system at any single time. If students are following a course curriculum with sandboxes or hands-on activities, the resource management system of the present invention will be able to analyze usage trends and direct resources to different hands on activities as needed, instead of the resource for each activity being static and causing bottlenecks and a bad user experience, which allows an organization to have a greater understanding of when to release their next wave of education modules or when to release new parts of course modules.

In a typical z/OS class, a storage object is used for activities for each course (or hackathon/demo/etc.), as well as for each lab environment deployed by each course. Each course is associated with a lab environment object. Prior to building any courses, system resources which may be used up are identified. The system resources can include inter alia: (i) physical limitations (e.g., number of processors, amount of storage, device addresses); (ii) capacity resources (e.g., number of Java® Virtual Machine (JVM) instances, virtual consoles); and (iii) entitlement-based resources (e.g., software licenses).

A course includes multiple sections, each section encompassing a different aspect of the course. For example, sections of an optics course may sections on electromagnetic waves, geometrical optics, interference, diffraction, etc. With resources defined, a course can be created (or modified) such that each section of the course has an associated list of resources that the user may potentially consume in the completion of the section. For example, Section #15 may require 1 VMware license, 8 GB of storage from a given storage class, and an ability to run a fairly large JVM for a sorting program.

Embodiments of the present invention introduce two new steps into the resource provisioning process to allow course developers to dynamically manage resources based on AI data trends: (i) a first extra step previews availability of resources used by the course before the course is deployed, which takes into consideration: course completion rates (observed and anticipated); identification and alleviation of potential bottlenecks, by a course developer, for enabling a resource management system to identify and alleviate the potential bottlenecks before the potential bottlenecks surface; spreading out tight restrictions; and allowing for reclamation of resources in response to determining that the resources are no longer needed between sections of the course; and (ii) a second step allows more learners to be on a system asynchronously, as the courseware now has an ability to determine when a particular resource is available based on course completion and to predict the availability of an allocated resource in the future based on existing data.

Unlike other resource sharing methods that move resources around based on immediate need, which can cause congestion and even cause a resource shortage, embodiments of the present invention leverage predictive machine leaning (ML) including AI combined with using a KNN algorithm in a unique way.

Typically, a KNN algorithm leverages pre-populated test data to start as a base and then further utilizes training points to enhance predictions. With each new course that comes out there is no preconceived test data. Courses in particular, take a little longer to become established and gain traction unlike other types of media such as YouTube® videos, where a lot of data is gained upfront on the video debut.

So, unlike videos where a majority of the data set information is presented within the first day or two, embodiments of the present invention leverage on the fly data collection by: focusing on the first few weeks of course use, continually compiling and creating a new testcase pool for each individual class until attainment of an ideal model that encompasses enough data sets. Each class has its own unique test data and unique training points specific to that particular class. The KNN algorithm per class continually fine tunes itself and determines predictive resource needs. At a level that sits above the KNN classification, embodiments of the present invention utilize these various sets of predictive analytics and funnels these various sets of predictive analytics through a top level manager to shift resources around without causing a resource shortage. Embodiments of the present invention detect where future resources are needed and can allocate access to specific courses accordingly.

Consider, for example, hackathons/events scheduled in advance. A reserve of X learners on a given date will likely cover sections A-B. Thus, if the bottleneck occurs in later sections, embodiments of the present invention ensures that there are enough resources for sections A-B available at the start date (and how long prior to launch of sections A-B to start evicting previous learners).

In another example, Exercise #10 requires allocation of a data set which is 5% of the total available space, but the average learner only uses that 5% space for less than one hour once started, and the section contains automation to reclaim the resource once the section is marked complete. It may be determined that it is safe to begin another learner on Exercise #9, which takes on average 3 hours to complete, with the understanding that the resource will be available for the learners of Exercise #10 when the resource is needed by the learners of Exercise #10.

Embodiments of the present invention are based on elements that reside in the course authoring software, the hosting system, as well as the system access software. When implemented, embodiments of the present invention allow for much greater flexibility and better optimization of pertinent resources while a course or hackathon is active.

Components of a system implementing embodiments of the present invention include: a Course Resource Allocation Facility, a Course Runtime Capacity Controller, a Lab Access Control Agent, a Lab Resource Management Facility, and AI Resource Management.

The Course Resource Allocation Facility includes an extension of a standard Self-Paced Virtual Learning offering, which allows for the association of lab resources to sections of a course, both in the setup, preview, and monitoring stages of course administration.

The Course Runtime Capacity Controller is a component that is responsible for making resources available, marking the resources as in-use, as well as providing clean-up after de-provisioning resources. In a z/OS system, this component may be responsible for attaching resources (e.g., devices, filesystems, and additional permissions) to users as needed.

When a resource is unavailable, the learner needs to be notified so that any system failures do not result in support desk calls. The Lab Access Control Agent is an extension of an existing learning platform, responsible for requesting access through the Lab Resource Management Facility, and for presenting feedback to the user, which may include a direct link to the resource, “loading” screens, optional actions to take while waiting, and status messages.

The Lab Resource Management Facility provides the ability to state resources in a whole or in quantity, as well as maximum allowable usage guidelines. As resources are requested by the Lab Access Control Agent, the Lab Resource Management Facility determines availability and provides or de-allocates access (through the Lab Access Control Agent) and returns a state to the requestor.

The AI Resource Management utilizes various sets of predictive analytics and funnels the predictive analytics through a top level manager to shift resources around without causing a resource shortage.

Embodiments of the present invention predict where a resource will be immediately needed based on a continuously changing set of data points and dynamically reassign static resources without the user suffering from a degradation of experience.

Embodiments of the present invention utilize both observed and anticipated course completion rates to identify and alleviate potential bottlenecks before the bottlenecks surface.

Embodiments of the present invention spread out and adjust tight restrictions, allowing for the reclamation of resources as the resources are no longer needed between sections.

Embodiments of the present invention enable a learner to asynchronously utilize a courseware platform through detecting resource availability based on predicting the future allocation of resources.

Embodiments of the present invention utilize machine learning, including KNN combined with a machine learning model (MLM), to dynamically allocate computer hardware and software resources for different sections of a course.

The MLM utilizes features pertaining to historical courses, and to the sections of the historical courses. Accordingly, the MLM is trained to learn how to predict hardware and software resource requirements of a course section from inputed features of the section. These features may include, inter alia, the number of learners (aka “students”), activities of the learners, required software and hardware usage, the duration of specific activities, and other relevant variables.

Once the MLM is trained, the MLM can be used to predict the resource requirements for each section of the course. By analyzing the features of a particular section, the MLM can estimate the necessary hardware and software resources needed to support that section effectively.

As new historical courses are added, the MLM can be retrained, resulting in the accuracy of the MLM being dynamically improved due to an expanded set of historical courses.

In addition, performance and resource utilization of each section can be continuously monitored to provide feedback data on actual resource usage, which may be compared with predictions made by the MLM, thus creating a feedback loop that refines and improves the accuracy of future predictions of course resource requirements. Thus, over time, the MLM can adapt and optimize resource allocation based on the feedback received. By continuously learning from the actual resource usage patterns, the MLM can update its predictions and adjust resource allocations accordingly.

Thus, embodiments of the present invention dynamically allocate resources to sections of a course based on the predictions made by the MLM, which can involve, for example, automatically provisioning hardware resources, allocating appropriate software licenses, adjusting virtual machine configurations, etc.

Embodiments of the present invention include allocating resources for: (i) a course being established and not yet implemented; and (ii) a course being implemented with actual learners.

Course being Developed or Modified

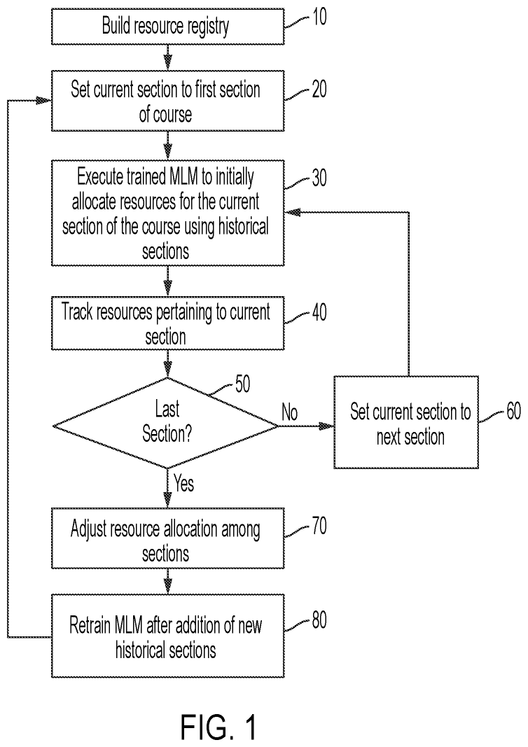

FIG. 1 is a flow chart describing an embodiment of a method for allocating resources to sections of a course, in accordance with embodiments of the present invention. The course includes a plurality of sections that includes a first section and a last section.

The flow chart of FIG. 1 includes steps 10-80.

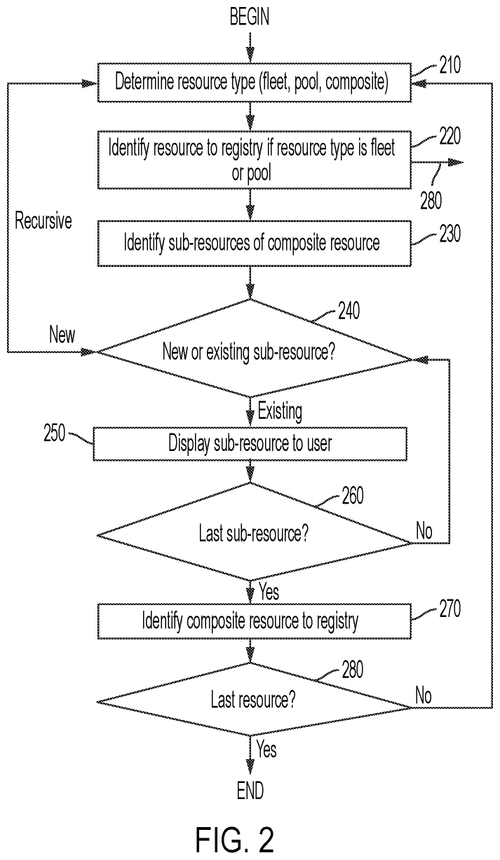

Step 10 builds a resource registry of resources used by the sections of the course and by other courses. The resource registry is stored on one or more storage devices of a computer system. Step 10 is described in more detail in FIG. 2.

Step 20 sets a current section to the first section of the course.

Step 30 executes a trained machine learning model (MLM) to initially allocate resources for the current section of the course, the trained MLM having been previously trained from data of multiple sections of respective historical courses using current instances of a feature vector respectively corresponding to each of the multiple sections. Each of the multiple sections is essentially a same section as the current section with respect subject matter content. Executing the trained MLM comprises using a first instance of a feature vector characterizing the current section as input to the trained MLM. The trained MLM comprises a K nearest neighbors (KNN) algorithm and a trained artificial intelligence (AI) model.

The feature vector of each section of the course includes a plurality of elements, each element being a feature of the section considered to impact resources needed for the section. Each element must be capable of being represented numerically.

Each section has its own section-specific feature vector which may include such features as, inter alia, number of students, number of lectures; average duration of lecture (e.g., in minutes); number of assignments; difficulty level (e.g., on a scale of 1 to 5); a binary indicator (0 or 1) representing whether the section has specific prerequisites; a binary indicator representing an availability of course materials (e.g., textbooks, lecture slides, etc.) for the section; communication medium (e.g., 1 in-person, 2 virtual).

Each instance of each feature vector is normalized to be in a fixed range of numerical values (e.g., 0 to 1) to prevent a domination of features whose numerical values are significantly higher than the numerical value of other features.

Executing the trained MLM includes using a first instance of the feature vector characterizing the current section as input to the trained MLM.

The trained MLM includes a K nearest neighbors (KNN) algorithm and a trained artificial intelligence (AI) model.

The AI model may be, inter alia, a neural network (e.g., a recurrent neural network (RNN), a feedforward neural network (FNN); a support vector machine (SVM); a Time Series Forecasting Model, etc.

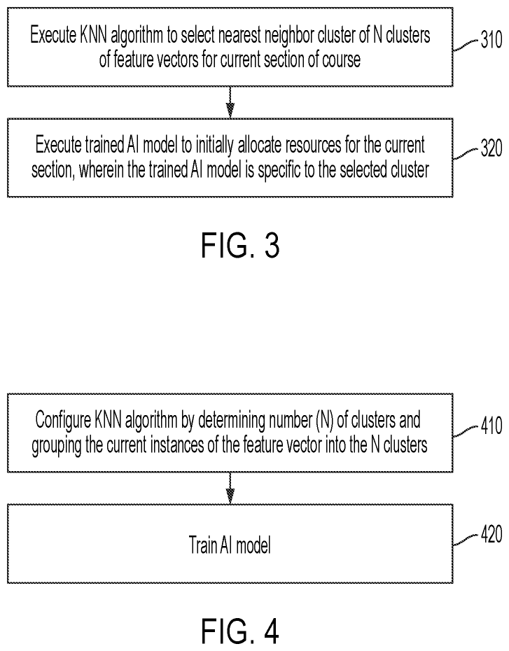

Step 30 is described in more detail in FIG. 3.

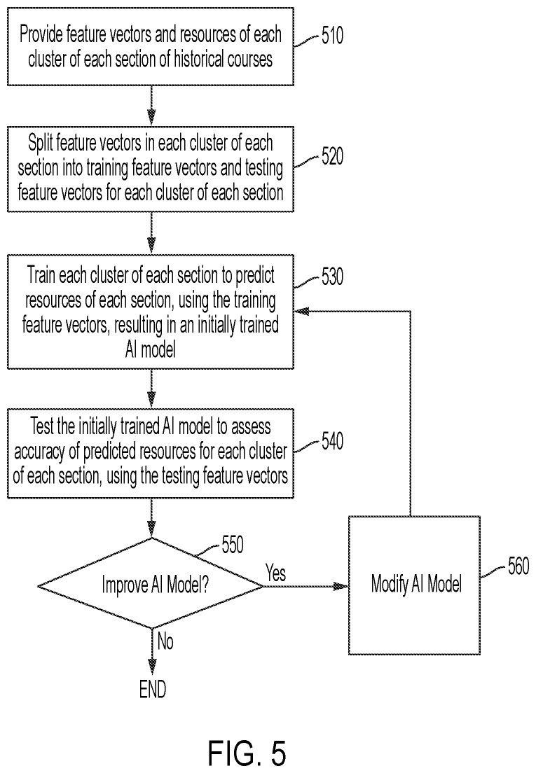

Training the MLM is described in FIGS. 4 and 5.

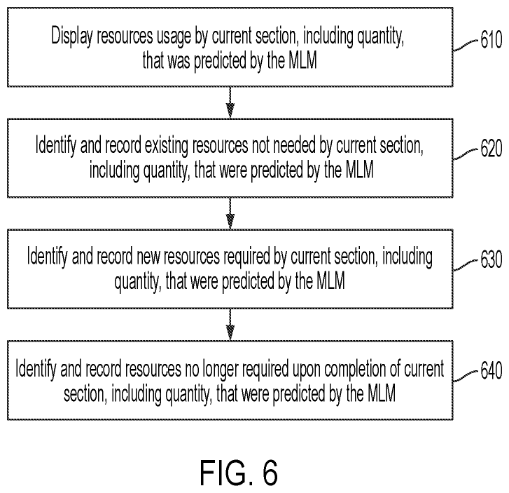

Step 40 tracks resources pertaining to the current section and is described in more detail in FIG. 6.

Step 50 determines whether the current section is the last section and is so then step 70 is next executed, and if not then step 60 sets the current section to a next section and branches back to step 30 to execute the trained MLM for the next section.

Step 70 adjusts resource allocation among the sections of the course to account for resource features that are specific to each section and that are not generally characteristic of features in the feature vectors used in the MLM.

The MLM for each section models each section individually and does not consider features affecting other sections. Accordingly in one embodiment, step 70 adjusts resource allocation among the sections based on resource features of each section that affect resource allocation in other sections.

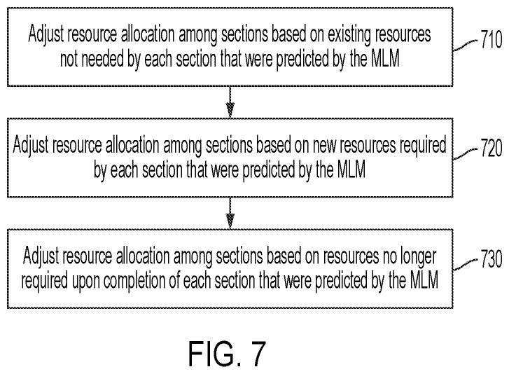

Step 70 is described in more detail in FIG. 7.

In response to adding new historical sections (corresponding to the sections of the course) to the MLM, step 80 retrains the MLM to account for the new historical sections in the MLM. The retraining of the MLM is in accordance with the process of training the MLM described in FIGS. 4 and 5. After the MLM is retrained, the method branches back to step 20 to reallocate the resources to the sections of the course using the retrained MLM.

The iterative loop through steps 10-80 constitutes a dynamic updating of the MLM and corresponding dynamic updating of resources allocated to the sections of the course.

FIG. 2 is a flow chart describing an embodiment of a process of building a resource registry of resources used by the sections of the course and by sections of other courses, in accordance with embodiments of the present invention.

The flow chart of FIG. 2 describes step 10 of FIG. 1 in more detail and includes steps 210-280 within a loop encompassing steps 210-280. Each iteration of the loop encompassing steps 210-280 is for one resource denoted as a current resource of a plurality of resources.

Step 210 determines a resource type of the current resource. The resource type may be a fleet resource, a pool resource, or a composite resource.

In one embodiment, the plurality of resources comprises at least one fleet resource.

In one embodiment, the plurality of resources comprises at least one pool resource.

In one embodiment, the plurality of resources comprises at least one composite resource.

A fleet resource is defined as a resource whose quantity is constant (e.g., 20 software licenses, 10 containers) and is assigned and used as whole, as in a fleet of vehicles or computers.

Examples of fleet resources include: Storage Volumes (e.g., D83WS1, D83WS2, D83WS3, D83WS4, . . . ); Database Instances (e.g., POKDB21, POKDB22, POKDB23, POKDB24, . . . ); and Network IP Addresses (e.g., 192.168.1.56, 192.168.1.85, 192.168.1.94, 192.168.1.201).

A pool resource is defined as a fungible resource (e.g., there may be 100 terabytes of memory or storage total, of which 10 terabytes can be allocated to one section and 20 terabytes can be allocated to another section, and 30 terabytes can be deleted from total terabytes because the 30 terabytes are no longer needed which changes the total number of terabytes). A pool resource is a collection of the same resource, which can be allocated in varying quantities.

Examples of pool resources include: Memory (e.g., 20 GB, where the system has 20 GB of available memory in a pool, and smaller portions of the 20 GB, such as 2 GB, 500 MB, 8 KB, etc. can be allocated); Bandwidth (e.g., 100 MB/Sec so if a network interface has a maximum of 100 MB/Sec, then QoS (Quality of Service) may be used to throttle/allocate bandwidth to users); and Software Licenses (e.g., if there are 100 licenses for VMWare, and a section of a course requires VMWare, the instructor would need to specify that the section consumes 1 license).

A composite resource is defined as a resource that comprises a plurality of sub-resources, each sub-resource being a fleet sub-resource or a pool sub-resource (e.g., one virtual machine having 2 software licenses and 8 gigabytes of memory).

Examples of composite resources include: a Virtual Machine comprising 8 GB of memory, 1 MB/Sec of bandwidth, 1 IP address, a storage volume, and an IP Address; a Development Environment comprising 20 GB of memory, 5 MB/Sec of bandwidth, 2 IP addresses, and 5 software licenses.

Step 220 identifies the current resource to the resource registry if the current resource is a fleet resource or a pool resource and program control then branches to step 280.

If the current resource is a composite resource, then steps 230-270 are next executed.

Step 230 identifies the sub-resources of the composite resource.

Steps 240-260 form a loop over the sub-resources of the composite resource.

Step 240 determines whether the sub-resource is an existing sub-resource or a new sub-resource.

If step 240 determines that the sub-resource is an existing sub-resource, then step 250 is next executed.

If step 240 determines that the sub-resource is a new sub-resource, then program control recursively branches to step 210 to determine whether the sub-resource is a fleet or pool type of sub-resource and recursively returns to step 240 and then to step 250.

In one embodiment, step 250 is executed to display the sub-resource to the user.

Step 260 determines whether the sub-resource is the last sub-resource and if so then step 270 is next executed; otherwise, program control branches back to step 250 to process the next sub-resource.

Step 270 identifies the composite resource, including the sub-resources, to the resource registry.

Step 280 determines whether the current resource is the last resource, and if so, then the process of FIG. 2 ends, and if not, program control loops back to step 210 to process the next resource.

Identifying a resource to the resource registry is defined as recording, in the resource registry, that the resource exists and recording a storage address at which the resource is stored, and includes for a composite resource: identifying the sub-resources of the composite resource and the storage address at which the sub-resources are stored.

In one embodiment, the resource is stored on the same one or more storage devices on which the resource registry is stored.

In one embodiment, the resource is stored on a different one or more storage devices than the one or more storage devices on which the resource registry is stored.

FIG. 3 is a flow chart describing an embodiment of a process of executing a trained machine learning model (MLM) for a current section of the course, in accordance with embodiments of the present invention.

The flow chart of FIG. 3 describes step 30 of FIG. 1 in more detail and includes steps 310-320.

Step 310 executes a KNN algorithm to select a nearest neighbor cluster of N clusters of feature vectors for the current section of course. The value of K (i.e., the number of nearest neighbors) is an odd integer of at least 1 and may be obtained, inter alia, from user input, or from experimentation that determines which value of K produces the best results. In one embodiment, K has a constant value that is used for all sections. In one embodiment, K is section-specific and may vary from section to section.

The selected cluster has a highest plurality of feature vector instances of K nearest-neighbor feature vector instances with respect to the first instance of the feature vector for the current section.

The feature vectors used by the KNN algorithm are distributed into N clusters which are specific to each section, wherein N is at least 2, as described in step 410 of FIG. 4. The neighbor distance between the feature vector of the current section and the feature vectors of the historical sections may be calculated as, inter alia, as a Euclidean distance, a Manhattan distance, etc. As stated supra, all feature vectors have been normalized to a same range (e.g., a range of 0 to 1) before being used by the KNN algorithm and by the AI model, so that no single feature dominates the KNN distance calculation.

Step 320 executes a trained AI model to initially allocate resources for the current section under a constraint of limiting the initially allocated resources to currently available resources, wherein the trained AI model is specific to the feature vectors in the cluster selected by the KNN algorithm. Executing the trained AI model uses as input: the first instance of the feature vector for the current section.

FIG. 4 is a flow chart describing an embodiment of a process of training the MLM, in accordance with embodiments of the present invention.

The flow chart of FIG. 4 includes steps 410-420.

Step 410 configures the KNN algorithm by determining number (N) of clusters and grouping the instances of the feature vectors into the N clusters for each section.

Determining the number of clusters (N) may be by any known process such as, inter alia, an elbow process or a silhouette analysis.

In the elbow process, candidate values of N are initially selected, and a K-Means clustering is applied using each of the initially selected candidate values of N, after which the average distance of each point in a cluster to the cluster's centroid is determined and represented in a curve of average distance versus N, wherein N is picked at an elbow of the curve where the average distance falls suddenly.

A silhouette analysis involves calculation and analysis of silhouette coefficients in conjunction with computation of silhouette scores from application of a K-means clustering model for each value of N, followed by an analysis of the silhouette scores in silhouette plots for each value of N, from which a best or highly favorable value of N is chosen.

The instances of the feature vectors are grouped into the N clusters for each section by applying a clustering algorithm such as a K-means algorithm that groups the feature vectors based on their feature similarities, in an attempt to generate clusters that are as homogeneous as possible.

Step 420 trains the AI model as described in more detail in FIG. 5.

FIG. 5 is a flow chart describing an embodiment of a process of training an artificial intelligence (AI) model of the MLM, in accordance with embodiments of the present invention.

FIG. 5 describes step 420 of FIG. 4 in more detail and includes steps 510-560.

The details of the AI model training depend on which AI model type is selected (e.g., a recurrent neural network (RNN), a feedforward neural network (FNN); a support vector machine (SVM); a Time Series Forecasting Model). Nonetheless, the flow chart of FIG. 5 is generally applicable to training any of the possible AI model types in specificity to training the AI model to predict resources for sections of a course.

Step 510 provides feature vectors and resources of each cluster of each section of the historical courses.

Step 520 splits the feature vectors in each cluster of each section into training feature vectors and testing feature vectors.

Step 530 trains each cluster of each section to predict resources of each section, using the training feature vectors, resulting in an initially trained AI model.

Step 540 tests the initially trained AI model to assess an accuracy of predicted resources for each cluster of each section, using the testing feature vectors.

Step 550 ascertains, from a result of the testing in step 540, whether the initially trained AI model should be improved and if so then modifying the AI model in step 560 to improve the AI mode, followed by re-executing: the training of the AI model, the testing of the trained AI model, and the ascertaining of whether the trained AI model should be improved in steps 530, 540, and 550, respectively.

Improving the AI model includes fine-tuning the parameters internal to the AI model to enable the AI model to output more accurate predictions of resources for each section of the course. The specific parameters to be fine-tuned depend on the type of AI model being used.

FIG. 6 is a flow chart describing an embodiment of a process of tracking current section resources, in accordance with embodiments of the present invention.

The flow chart of FIG. 6 describes step 40 of FIG. 1 in more detail and includes steps 610-640.

Step 610 displays resources usage by the current section, including quantity, that was predicted by the MLM.

Step 620 identifies and records existing resources not needed by the current section, including quantity, that were predicted by the MLM.

Step 630 identifies and records new resources required by the current section, including quantity, that were predicted by the MLM.

Step 640 identifies and records resources no longer required upon completion of current section, including quantity, that were predicted by the MLM.

FIG. 7 is a flow chart describing an embodiment of a process of adjusting resource allocation among the sections of the course, in accordance with embodiments of the present invention.

The flow chart of FIG. 7 describes step 70 of FIG. 1 in more detail and includes steps 710-730.

Use of the trained MLM predicts course requirements for each section individually based on historical sections of courses but does not take into account specifics of the sections of the course that do not conform to the feature vectors used to train and execute the MLM. Such section specifics are described in the process of FIG. 6 and are utilized in the process of FIG. 7 for adjusting resources among the sections.

Step 710 adjusts resource allocation among the sections based on existing resources not needed by each section that were predicted by the MLM. For example, a virtual machine predicted by the MLM for a particular section based on historical use of the virtual machine may not be needed by the particular section because of a difference in the syllabus of the particular section in contrast with the syllabus generally used in the historical sections.

Step 720 adjusts resource allocation among the sections based on new resources required by each section that were predicted by the MLM. For example, the predicted new resource for a particular section, which is not in the resource registry, may be replaceable by another resource in the resource registry for providing the functionality supported by the new resource.

Step 730 adjusts resource allocation among the sections based on resources no longer required upon completion of each section that were predicted by the MLM. For example, a resource no longer required by any section upon completion of section X, but had been previously needed by the next section X+1, can be deleted from resources allocated to section X+1.

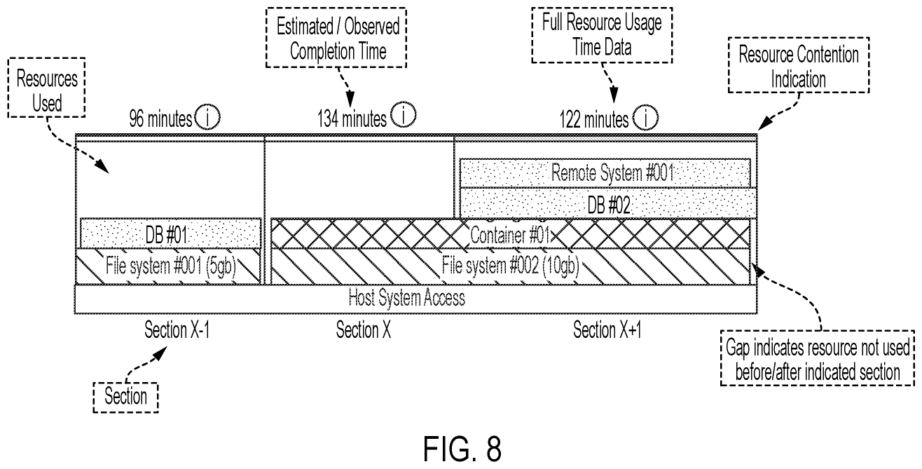

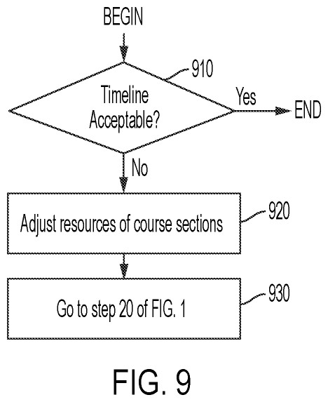

FIG. 8 depicts a timeline of the course, in accordance with embodiments of the present invention.

In one embodiment, the timeline in FIG. 8 is generated from knowledge of the resources allocated to the sections of the course via implementation of the method of FIGS. 1-7.

The timeline is generated in accordance with availability of the resources allocated to the sections of the course following performance of step 70 of FIG. 1. In this embodiment, the process of FIG. 9 can be performed.

FIG. 9 is a process of examining the timeline of FIG. 8, in accordance with embodiments of the present invention. The process of FIG. 9 includes steps 910-930.

Step 910 determines whether the timeline is acceptable, based on, inter alia, pre-determined timing requirements for each section of the course. The timing requirements may pertain to minimum and/or maximum time duration and/or dates for each section, and/or minimum and/or maximum time duration and/or dates for the entire course.

If step 910 determines that the timeline is acceptable, then the process of FIG. 9 ends.

If step 910 determines that the timeline is not acceptable, then step 920 adjusts the resources of the sections to generate a new timeline that is acceptable.

In one embodiment, the process of FIG. 9 ends after step 920 is performed.

In one embodiment in step 930, the process branches to step 20 of FIG. 1 after step 920 is performed, in an attempt to further improve the resource allocations to the sections of the course.

Course being Implemented

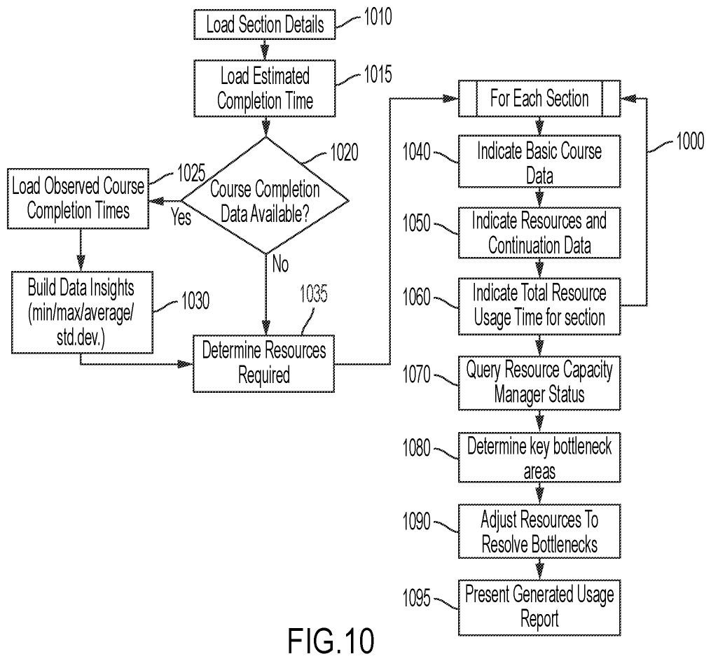

FIG. 10 is a flow chart of a live implementation of the course in accordance with the resources allocated to the sections of the course, in accordance with embodiments of the present invention.

The flow chart of FIG. 10, which includes steps 1010-1095, is performed using the resource allocation to the sections of the course provided via execution of the method of FIG. 1.

The process of FIG. 10 tracks consumption of resources as the live course implementation progresses.

The process of FIG. 10 can be executed continuously, periodically, or sporadically, while the live course is running.

Step 1010 loads section details comprising the estimated resource allocations for the sections of the course as determined from execution of the method of FIG. 1.

Step 1015 loads the estimated section completion times that appear in the timeline of FIG. 8.

Step 1020 determines whether course completion data (i.e., section completion times and course completion times) is available. If the course is being run for the first time, then course completion data is not available. If the course has been run one or more times previously, then course completion data is available if such course data was recorded and saved.

If step 1020 determines that course completion data is available,
then steps 1025 and 1030 are next executed; otherwise, step 1035 is next executed.

Step 1025 loads the course completion data of previously runs of the course.

Step 1030 builds data insights pertaining to the course completion data that was loaded. Such insights may include minimum, maximum, and average section and course completion times and associated standard deviations.

In addition, differences between the estimated and observed completion times of the sections and the course may be obtained from steps 1015 and 1025, respectively, and both an average and a standard deviation of such differences may be computed and then interpreted as data insights.

Step 1035 determines the resources required from each section as being the allocated resources for each section from performing the method of FIG. 1.

Steps 1040-1060 are executed for each section as indicated by loop 1000.

Step 1040 indicates basic course data comprising the features comprised by the feature vector instance for the section.

Step 1050 indicates resources and continuation data comprising the resources allocated to the section from execution of the method of FIG. 1.

Step 1060 indicates total resource usage time for the section during the live course for each resource used.

Steps 1070-1090 are executed after the loop 1000 has been executed for all of the sections.

Step 1070 queries resource capacity manager status which is a query to the system as to what quantity of each resource is available. For example, if one Java Virtual Machine (JVM) per student is needed for one or more sections or for the entire course, and if only 20 JVMs are available, then the course can accommodate no more than 20 students.

In one embodiment, the query may be answered by the system based on the insight obtained in step 1030.

Step 1080 determines key bottleneck areas that impede implementation of the sections in the live course. Examples of bottlenecks include: insufficiency (e.g., insufficient quantity) of a resource used by the students of one or more sections; more students taking the course than can be accommodated by the available resources; a consumption rate of a resource being incompatible with a range of acceptable timelines for the course, etc.

Step 1090 adjusts resources to resolve bottleneck(s). In one embodiment, step 1090 adjusts the resources by using an artificial intelligence (AI) model that predicts resource adjustments based on historical data, namely previously used resource adjustments performed to resolve similar bottlenecks that previously occurred. The preceding AI model is analogous to the AI model mentioned in step 320 in FIG. 3 and trained as described in FIG. 5.

Step 1095 generates a usage report that describes how resources are used in the implementation of the live course.

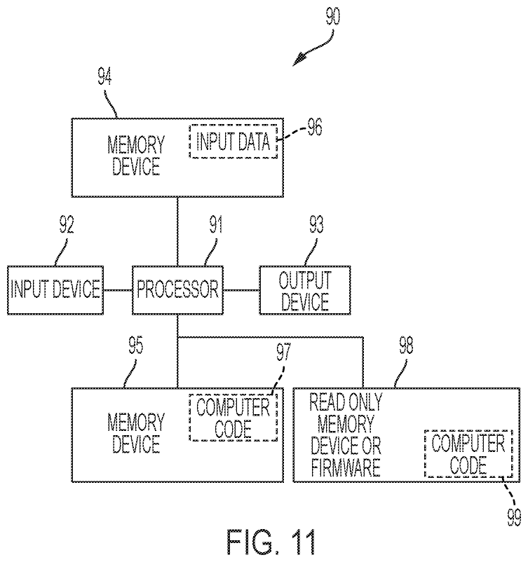

FIG. 11 illustrates a computer system 90, in accordance with embodiments of the present invention.

The computer system 90 includes a processor 91, an input device 92 coupled to the processor 91, an output device 93 coupled to the processor 91, and memory devices 94 and 95 each coupled to the processor 91. The processor 91 represents one or more processors and may denote a single processor or a plurality of processors. The input device 92 may be, inter alia, a keyboard, a mouse, a camera, a touchscreen, etc., or a combination thereof. The output device 93 may be, inter alia, a printer, a plotter, a computer screen, a magnetic tape, a removable hard disk, a floppy disk, etc., or a combination thereof. The memory devices 94 and 95 may each be, inter alia, a hard disk, a floppy disk, a magnetic tape, an optical storage such as a compact disc (CD) or a digital video disc (DVD), a dynamic random access memory (DRAM), a read-only memory (ROM), etc., or a combination thereof. The memory device 95 includes a computer code 97. The computer code 97 includes algorithms for executing embodiments of the present invention. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices such as read only memory device 96) may include algorithms and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

In some embodiments, rather than being stored and accessed from a hard drive, optical disc or other writeable, rewriteable, or removable hardware memory device 95, stored computer program code 99 (e.g., including algorithms) may be stored on a static, nonremovable, read-only storage medium such as a Read-Only Memory (ROM) device 98, or may be accessed by processor 91 directly from such a static, nonremovable, read-only medium 98. Similarly, in some embodiments, stored computer program code 99 may be stored as computer-readable firmware, or may be accessed by processor 91 directly from such firmware, rather than from a more dynamic or removable hardware data-storage device 95, such as a hard drive or optical disc.

Still yet, any of the components of the present invention could be created, integrated, hosted, maintained, deployed, managed, serviced, etc. by a service supplier who offers to improve software technology associated with cross-referencing metrics associated with plug-in components, generating software code modules, and enabling operational functionality of target cloud components. Thus, the present invention discloses a process for deploying, creating, integrating, hosting, maintaining, and/or integrating computing infrastructure, including integrating computer-readable code into the computer system 90, wherein the code in combination with the computer system 90 is capable of performing a method for enabling a process for improving software technology associated with cross-referencing metrics associated with plug-in components, generating software code modules, and enabling operational functionality of target cloud components. In another embodiment, the invention provides a business method that performs the process steps of the invention on a subscription, advertising, and/or fee basis. That is, a service supplier, such as a Solution Integrator, could offer to enable a process for improving software technology associated with cross-referencing metrics associated with plug-in components, generating software code modules, and enabling operational functionality of target cloud components. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 11 shows the computer system 90 as a particular configuration of hardware and software, any configuration of hardware and software, as would be known to a person of ordinary skill in the art, may be utilized for the purposes stated supra in conjunction with the particular computer system 90 of FIG. 11. For example, the memory devices 94 and 95 may be portions of a single memory device rather than separate memory devices.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

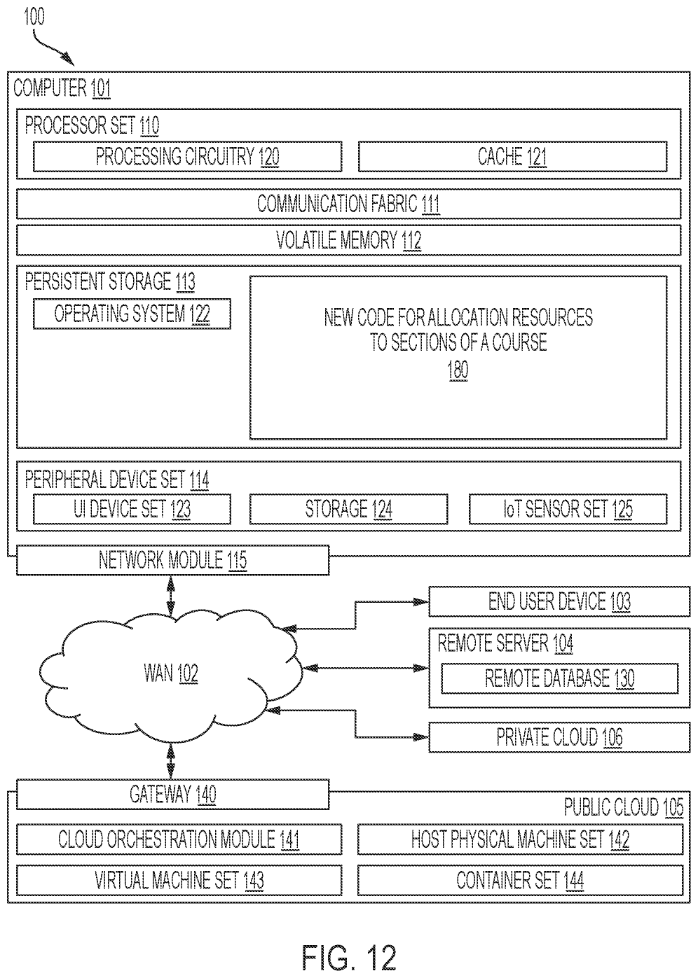

FIG. 12 depicts a computing environment 100 which contains an example of an environment for the execution of at least some of the computer code involved in performing the inventive methods, in accordance with embodiments of the present invention. Such computer code includes new code for allocating resources to sections of a course 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 12. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for allocating resources to sections of a course, said course comprising a plurality of sections that includes a first section and a last section, said method comprising the following steps starting with a current section of the course being the first section of the course:
(a) executing, by one or more processors of a computer system, a trained machine learning model (MLM) to initially allocate resources for the current section of the course, said trained MLM having been previously trained from data of multiple sections of respective historical courses using current instances of a feature vector respectively corresponding to each of the multiple sections, each of the multiple sections being essentially a same section as the current section, said executing the trained MLM comprising using a first instance of a feature vector characterizing the current section as input to the trained MLM, wherein the trained MLM comprises a K nearest neighbors (KNN) algorithm and a trained artificial intelligence (AI) model;
(b) determining, by the one or more processors, whether the current section is the last section, and if so, then next performing step (c), and if not then re-performing step (a) with the current section being a next section of the course; and
(c) adjusting, by one or more processors, resource allocation among the plurality of sections as deviations from the initially allocated resources to each section, said deviations being based on resource limitations that are specific to each section individually and are not generally encompassed by the sections of the historical courses, wherein software resources configured for use by the plurality of sections of the course and for use by sections of other courses are included in a resource registry stored on one or more storage devices of the computer system.

2. The method of claim 1, said method further comprising:
retraining, by the one or more processors, the MLM after at least one additional section has been added to the multiple sections corresponding to at least one section of the course, resulting in the trained MLM being improved for allocating resources; and
after said re-training the MLM, re-executing steps (a), (b) and (c) using the improved trained MLM, which dynamically improves a distribution of the re-allocated resources.

3. The method of claim 1, wherein current instances of the feature vector are grouped within N clusters of feature vectors, wherein N is at least 2, and wherein said executing the trained MLM for the current section comprises:
executing the trained KNN algorithm to select a cluster of the N clusters, wherein the selected cluster has a highest plurality of feature vector instances of K nearest-neighbor feature vector instances with respect to the first instance of the feature vector for the current section, and wherein K is an odd positive integer of at least 1; and
executing the trained AI model to initially allocate resources for the current section under a constraint of limiting the initially allocated resources to currently available resources, said trained AI model being specific to the feature vectors in the selected cluster, said executing the trained AI model using as input: the first instance of the feature vector for the current section and an identification of the currently available resources.

4. The method of claim 3, said method further comprising training, by the one or more processors, the MLM, wherein said training the MLM comprises: configuring the KNN algorithm for being subsequently executed; and training the AI model.

5. The method of claim 4, wherein said configuring the KNN algorithm comprises:
determining the number (N) of clusters;
grouping, using a clustering algorithm, the current instances of the feature vector into the N clusters.

6. The method of claim 4, wherein said training the AI model comprises:
providing feature vectors and resources of each cluster of each section of the historical courses;
splitting the feature vectors in each cluster of each section into training feature vectors and testing feature vectors;
training each cluster of each section to predict resources of each section, using the training feature vectors, resulting in an initially trained AI model;
testing the initially trained AI model to assess an accuracy of predicted resources for each cluster of each section, using the testing feature vectors; and
ascertaining, from a result of said testing, whether the initially trained AI model should be improved, and if so, then modifying the AI model followed re-executing steps (a)-(c).

7. The method of claim 1, said method comprising building, by the one or more processors, the resource registry from a plurality of resources, said building comprising for each current resource of the plurality of resources:
determining whether the current resource is a fleet resource, a pool resource, or a composite resource;
if the current resource is determined to be a composite resource, then identifying a plurality of sub-resources of the composite resource and identifying whether each sub-resource is a fleet sub-resource or a pool sub-resource; and
identifying the current resource to the resource registry,
wherein the plurality of resources comprises at least one fleet resource, at least one pool resource, and at least one composite resource.

8. The method of claim 1, said method further comprising:
generating, after step (c) by the one or more processors, a timeline of the course in accordance with availability of the resources allocated to the sections of the course;
in response to a determination by the one or more processors that the timeline is not acceptable, adjusting, by the one or more processors, the resources of the sections to generate a new timeline that is acceptable.

9. The method of claim 1, said method further comprising:
after step (c), performing a live implementation of the course in accordance with the resources allocated to the sections of the course.

10. The method of claim 9, wherein said performing the live implementation of the course for one section of the course comprises:
determining, by the one or more processors, a bottleneck that impedes implementation of the one section and in response, eliminating, by the one or more processors, the bottleneck by modifying the resources allocated to the one section.

11. A computer program product, comprising one or more computer readable hardware storage devices having computer readable program code stored therein, said program code containing instructions executable by one or more processors of a computer system to implement a method for allocating resources to sections of a course, said course comprising a plurality of sections that includes a first section and a last section, said method comprising the following steps starting with a current section of the course being the first section of the course:
(a) executing, by the one or more processors, a trained machine learning model (MLM) to initially allocate resources for the current section of the course, said trained MLM having been previously trained from data of multiple sections of respective historical courses using current instances of a feature vector respectively corresponding to each of the multiple sections, each of the multiple sections being essentially a same section as the current section, said executing the trained MLM comprising using a first instance of a feature vector characterizing the current section as input to the trained MLM, wherein the trained MLM comprises a K nearest neighbors (KNN) algorithm and a trained artificial intelligence (AI) model;
(b) determining, by the one or more processors, whether the current section is the last section, and if so, then next performing step (c), and if not then re-performing step (a) with the current section being a next section of the course; and
(c) adjusting, by one or more processors, resource allocation among the plurality of sections as deviations from the initially allocated resources to each section, said deviations being based on resource limitations that are specific to each section individually and are not generally encompassed by the sections of the historical courses, wherein software resources configured for use by the plurality of sections of the course and for use by sections of other courses are included in a resource registry stored on one or more storage devices of the computer system.

12. The computer program product of claim 11, wherein current instances of the feature vector are grouped within N clusters of feature vectors, wherein N is at least 2, and wherein said executing the trained MLM for the current section comprises:
executing the trained KNN algorithm to select a cluster of the N clusters, wherein the selected cluster has a highest plurality of feature vector instances of K nearest-neighbor feature vector instances with respect to the first instance of the feature vector for the current section, and wherein K is an odd positive integer of at least 1; and
executing the trained AI model to initially allocate resources for the current section under a constraint of limiting the initially allocated resources to currently available resources, said trained AI model being specific to the feature vectors in the selected cluster, said executing the trained AI model using as input: the first instance of the feature vector for the current section and an identification of the currently available resources.

13. The computer program product of claim 12, said method further comprising training, by the one or more processors, the MLM, wherein said training the MLM comprises: configuring the KNN algorithm for being subsequently executed; and training the AI model.

14. The computer program product of claim 13, wherein said configuring the KNN algorithm comprises:
determining the number (N) of clusters;
grouping, using a clustering algorithm, the current instances of the feature vector into the N clusters.

15. The computer program product of claim 13, wherein said training the AI model comprises:
providing feature vectors and resources of each cluster of each section of the historical courses;
splitting the feature vectors in each cluster of each section into training feature vectors and testing feature vectors;
training each cluster of each section to predict resources of each section, using the training feature vectors, resulting in an initially trained AI model;
testing the initially trained AI model to assess an accuracy of predicted resources for each cluster of each section, using the testing feature vectors; and
ascertaining, from a result of said testing, whether the initially trained AI model should be improved and if so then modifying the AI model followed re-executing steps (a)-(c).

16. A computer system, comprising one or more processors, one or more memories, and one or more computer readable hardware storage devices, said one or more hardware storage devices containing program code executable by the one or more processors via the one or more memories to implement a method for allocating resources to sections of a course, said course comprising a plurality of sections that includes a first section and a last section, said method comprising the following steps starting with a current section of the course being the first section of the course:
(a) executing, by the one or more processors, a trained machine learning model (MLM) to initially allocate resources for the current section of the course, said trained MLM having been previously trained from data of multiple sections of respective historical courses using current instances of a feature vector respectively corresponding to each of the multiple sections, each of the multiple sections being essentially a same section as the current section, said executing the trained MLM comprising using a first instance of a feature vector characterizing the current section as input to the trained MLM, wherein the trained MLM comprises a K nearest neighbors (KNN) algorithm and a trained artificial intelligence (AI) model;
(b) determining, by the one or more processors, whether the current section is the last section, and if so, then next performing step (c), and if not then re-performing step (a) with the current section being a next section of the course; and
(c) adjusting, by one or more processors, resource allocation among the plurality of sections as deviations from the initially allocated resources to each section, said deviations being based on resource limitations that are specific to each section individually and are not generally encompassed by the sections of the historical courses, wherein software resources configured for use by the plurality of sections of the course and for use by sections of other courses are included in a resource registry stored on one or more storage devices of the computer system.

17. The computer system of claim 16, said method further comprising:
retraining, by the one or more processors, the MLM after at least one additional section has been added to the multiple sections corresponding to at least one section of the course, resulting in the trained MLM being improved for allocating resources; and
after said re-training the MLM, re-executing steps (a), (b) and (c) using the improved trained MLM, which dynamically improves a distribution of the re-allocated resources.

18. The computer system of claim 16, said method further comprising:
generating, after step (c) by the one or more processors, a timeline of the course in accordance with availability of the resources allocated to the sections of the course;
in response to a determination by the one or more processors that the timeline is not acceptable, adjusting, by the one or more processors, the resources of the sections to generate a new timeline that is acceptable.

19. The computer system of claim 16, said method further comprising:
after step (c), performing a live implementation of the course in accordance with the resources allocated to the sections of the course.

20. The computer system of claim 19, wherein said performing the live implementation of the course for one section of the course comprises:
determining, by the one or more processors, a bottleneck that impedes implementation of the one section and in response, eliminating, by the one or more processors, the bottleneck by modifying the resources allocated to the one section.
